(19) United States
(12) Patent Application Publication
(10) Pub. No.: US 2026/0235754 A1
(43) Pub. Date: Aug. 13, 2026

(54) 3D ULTRASONIC VOXEL GENERATION METHOD, VEHICLE, AND COMPUTER-READABLE RECORDING MEDIUM INCLUDING INSTRUCTIONS FOR PERFORMING 3D ULTRASONIC VOXEL GENERATION METHOD

(71) Applicants: HYUNDAI MOTOR COMPANY, Seoul (KR); KIA CORPORATION, Seoul (KR)

(72) Inventors: Jun Ho KOH, Hwaseong-si (KR); Jun Hyung KIM, Hwaseong-si (KR); Da Ye OH, Hwaseong-si (KR)

(21) Appl. No.: 19/538,464

(22) Filed: Feb. 12, 2026

(30) Foreign Application Priority Data
Feb. 13, 2025 (KR) 10-2025-0018590

(51) Int. Cl. G01S 15/931; B60W 60/00; G01S 15/06; G01S 15/58

(52) U.S. Cl. CPC G01S 15/931; B60W 60/001; G01S 15/06; G01S 15/58

(57) ABSTRACT

There is provided a method for generating a 3D ultrasonic voxel. The method, performed by an apparatus of a vehicle, may include obtaining a plurality of ultrasonic signals, detected at a plurality of times, representing one or more objects in a surrounding environment of the vehicle; determining, among the plurality of ultrasonic signals, one or more reference ultrasonic signals and one or more non-reference ultrasonic signals; processing motion compensation on the one or more reference ultrasonic signals and the one or more non-reference ultrasonic signals; generating a reference ultrasonic voxel feature map and one or more non-reference ultrasonic voxel feature maps; generating a final ultrasonic voxel feature map by combining the reference ultrasonic voxel feature map and the one or more non-reference ultrasonic voxel feature maps; and controlling, based on the final ultrasonic voxel feature map, an autonomous driving operation of the vehicle.

### CROSS-REFERENCE TO RELATED APPLICATION

This application claims priority to and the benefit of Korean Patent Application No. 10-2025-0018590, filed Feb. 13, 2025 in the Korean Intellectual Property Office, the disclosure of which is incorporated herein by reference in its entirety.

### TECHNICAL FIELD

This disclosure relates to a vehicle and a control method therefor, and more specifically, to an object detection technology of an autonomous vehicle.

### BACKGROUND

An autonomous vehicle can recognize a road environment by itself, determine a driving condition, and move from an origin location to a destination location along a planned driving path.

The autonomous vehicle may use a sensor fusion device (e.g., sensor array), and the sensor fusion device may allow recognizing other vehicles, obstacles, and roads through a combination of various sensors such as a camera, a radar, and/or a lidar.

A signal from an ultrasonic sensor may include distance information, and such a signal may be used for recognizing a nearby object in a near field of view. In particular, an ultrasonic voxel feature map may be constructed by combining ultrasonic signals and may be used for object recognition.

However, since a signal that is output from the ultrasonic sensor has the characteristic of spatial ambiguity, it cannot always be reliably determined whether an object exists at a given distance, and filtering based on signal processing may be limited in robustness, making it difficult to recognize an object.

The matters described in this Background section are only for enhancement of understanding of the background of the disclosure, and should not be taken as acknowledgement that they correspond to prior art already known to those skilled in the art.

### SUMMARY

The present disclosure is directed to providing a method and a vehicle for combining ultrasonic signals detected at different times to construct an ultrasonic voxel feature map.

Further, the present disclosure is directed to providing a method and a vehicle capable of resolving spatial ambiguity and reliably detecting an object in various situations generated based on ultrasonic signals by combining ultrasonic signals to construct an ultrasonic voxel feature map.

According to one or more example embodiments of the present disclosure, a method performed by an apparatus of a vehicle may include: obtaining, from one or more ultrasonic sensors mounted on the vehicle, a plurality of ultrasonic signals detected at a plurality of times; determining, among the plurality of ultrasonic signals: one or more reference ultrasonic signals detected at a reference time of the plurality of times, and one or more non-reference ultrasonic signals detected at one or more non-reference times of the plurality of times; processing motion compensation on the one or more reference ultrasonic signals and the one or more non-reference ultrasonic signals; generating, based on the one or more motion-compensated reference ultrasonic signals, a reference ultrasonic voxel feature map; generating, based on the one or more motion-compensated non-reference ultrasonic signals, one or more non-reference ultrasonic voxel feature maps; generating a final ultrasonic voxel feature map by combining the reference ultrasonic voxel feature map and the one or more non-reference ultrasonic voxel feature maps; and controlling, based on the final ultrasonic voxel feature map, an autonomous driving operation of the vehicle. The plurality of ultrasonic signals may represent one or more objects in a surrounding environment of the vehicle.

Processing the motion compensation may include: determining a speed of the vehicle and a heading angle of the vehicle; determining a position of the vehicle by applying the determined speed and the heading angle to an initial position of the vehicle; and processing the motion compensation based on the determined position of the vehicle. Determining the speed of the vehicle and the heading angle of the vehicle may include: determining a wheel speed of a plurality of wheels of the vehicle; and determining the speed of the vehicle based on the wheel speed of the vehicle.

Determining the speed of the vehicle and the heading angle of the vehicle may include: determining a steering angle of the vehicle; and determining the speed of the vehicle based on the steering angle of the vehicle.

The method may further include: determining, based on the speed of the vehicle and the heading angle of the vehicle, a mounting angle of the one or more ultrasonic sensors and a mounting position of the one or more ultrasonic sensors.

Generating the reference ultrasonic voxel feature map may include: filtering, among the one or more reference ultrasonic signals, one or more signals that exceed a maximum detection distance of the one or more ultrasonic sensors; and generating a first ultrasonic voxel heat map at the reference time by projecting signal intensities of the one or more reference ultrasonic signals onto one or more first voxels. Generating the one or more non-reference ultrasonic voxel feature maps may include: filtering, among the one or more non-reference ultrasonic signals, one or more signals that exceed the maximum detection distance of the one or more ultrasonic sensors; and generating second ultrasonic voxel heat maps at the non-reference times by projecting signal intensities of the one or more non-reference ultrasonic signals onto one or more second voxels.

Generating the final ultrasonic voxel feature map may include: concatenating the reference ultrasonic voxel feature map and the one or more non-reference ultrasonic voxel feature maps to generate a voxel feature map; summing the voxel feature map by each channel of the voxel feature map; and generating the final ultrasonic voxel feature map by inputting the summed voxel feature map to an ultrasonic feature map generation model.

According to one or more example embodiments of the present disclosure, a vehicle may include: one or more ultrasonic sensors configured to detect, at a plurality of times, a plurality of ultrasonic signals representing one or more objects in a surrounding environment of the vehicle; a processor; and a memory storing at least one instruction. The at least one instruction may be configured, when executed by the processor, to cause the vehicle to: process motion compensation on: one or more reference ultrasonic signals, of the plurality of ultrasonic signals, that are detected at a reference time of the plurality of times, and one or more non-reference ultrasonic signals, of the plurality of ultrasonic signals, that are detected at one or more non-reference times of the plurality of times; generate, based on the one or more motion-compensated reference ultrasonic signals, a reference ultrasonic voxel feature map; generate, based on the one or more motion-compensated non-reference ultrasonic signals, one or more non-reference ultrasonic voxel feature maps; generate a final ultrasonic voxel feature map by combining the reference ultrasonic voxel feature map and the one or more non-reference ultrasonic voxel feature maps; and control, based on the final ultrasonic voxel feature map, an autonomous driving operation of the vehicle.

The at least one instruction may be configured, when executed by the processor, to cause the vehicle to process the motion compensation by: determining a speed of the vehicle and a heading angle of the vehicle; determining a position of the vehicle by applying the determined speed and the determined heading angle to an initial position of the vehicle; and processing the motion compensation based on the determined position of the vehicle.

The at least one instruction may be configured, when executed by the processor, to cause the vehicle to determine the speed of the vehicle and the heading angle of the vehicle by: determining a wheel speed of a plurality of wheels of the vehicle; and determining the speed of the vehicle based on the wheel speed of the vehicle.

The at least one instruction may be configured, when executed by the processor, to cause the vehicle to determine the speed of the vehicle and the heading angle of the vehicle by: determining a steering angle of the vehicle; and determining the speed of the vehicle based on the steering angle of the vehicle.

The at least one instruction may be configured, when executed by the processor, to further cause the vehicle to: determine, based on the speed of the vehicle and the heading angle of the vehicle, a mounting angle of the one or more ultrasonic sensors and a mounting position of the one or more ultrasonic sensors.

The at least one instruction may be configured, when executed by the processor, to further cause the vehicle to: filter, among the one or more reference ultrasonic signals and the one or more non-reference ultrasonic signals, one or more signals that exceed a maximum detection distance of the one or more ultrasonic sensors; and generating an ultrasonic voxel heat map by project signal intensities of the one or more reference ultrasonic signals and the one or more non-reference ultrasonic signals onto voxels.

The at least one instruction may be configured, when executed by the processor, to cause the vehicle to generate the final ultrasonic voxel feature map by: concatenating the reference ultrasonic voxel feature map and the one or more non-reference ultrasonic voxel feature maps to generate a voxel feature map; summing the voxel feature map by each channel of the voxel feature map; and generating the final ultrasonic voxel feature map by inputting the summed voxel feature map to an ultrasonic feature map generation model.

According to one or more example embodiments of the present disclosure, a non-transitory computer-readable medium may store instructions that, when executed by a computing device, cause the computing device to: obtain, from an ultrasonic sensor of a vehicle at a first time, a first non-reference signal representing one or more objects in a surrounding environment of the vehicle; obtain, from the ultrasonic sensor at a second time after the first time, a second non-reference signal representing the one or more objects; obtain, from the ultrasonic sensor at a third time after the second time, a reference signal representing the one or more objects; generate, based on the first non-reference signal and the second non-reference signal, a plurality of non-reference ultrasonic voxel feature maps; generate, based on the reference signal, a reference ultrasonic voxel feature map; and control, based on the reference ultrasonic voxel feature map and the plurality of non-reference ultrasonic voxel feature maps, an autonomous driving operation of the vehicle.

The instructions, when executed by the computing device, may further cause the computing device to: process motion compensation on the first non-reference signal, the second non-reference signal, and the reference signal.

The instructions, when executed by the computing device, may cause the computing device to control the autonomous driving operation of the vehicle by: causing the vehicle to avoid the one or more objects.

According to the present disclosure, it is possible to construct an ultrasonic voxel feature map having a sophisticated 3D voxel expression by combining ultrasonic signals detected at different times.

Further, according to the present disclosure, it is possible to resolve spatial ambiguity and reliably detect an object in various situations generated based on ultrasonic signals by combining ultrasonic signals to construct an ultrasonic voxel feature map.

The advantages and effects attainable through the present disclosure are not limited to those expressly recited above. Additional advantages and effects, which have not been explicitly mentioned, will be apparent to, and readily appreciated by, those of ordinary skill in the art to which the present disclosure pertains from the following description.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings.

FIG. 1 is a view illustrating an example vehicle transmitting and receiving data by communicating with one or more other devices.

FIG. 2 is a diagram showing example modules constituting a vehicle.

FIG. 3 is a diagram conceptually showing a function of an example 3D ultrasonic voxel generation program of FIG. 2.

FIG. 4 is a diagram illustrating a kinematic bicycle model used in an example D ultrasonic voxel generation program.

FIG. 5 is a diagram illustrating an ultrasonic feature map generation model used in an example 3D ultrasonic voxel program.

FIG. 6 is a flowchart illustrating an operation of an example ultrasonic feature map generation method.

### DETAILED DESCRIPTION

The advantages and features of the example embodiment(s) and the methods of accomplishing the example embodiment(s) will be clearly understood from the following description taken in conjunction with the accompanying drawings. However, the present disclosure is not limited to the example embodiment(s) described, as the example embodiment(s) may be implemented in various forms. It should be noted that the present example embodiment(s) are provided to make a full disclosure and also to allow those skilled in the art to know the full range of the present disclosure. Therefore, the present disclosure is to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, the meaning of the terms used herein will be described in detail in the description of corresponding example embodiment(s). Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit” may be configured to be stored in an addressable storage medium, or may be configured to execute one or more processors. The “unit” may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., generating a voxel feature map based on multiple ultrasonic signals detected over time) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., generating a voxel feature map based on multiple ultrasonic signals detected over time) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., generating a voxel feature map based on multiple ultrasonic signals detected over time) described herein.

Minimum risk maneuver (MRM) operation(s) may also be controlled, for example, based on one or more features (e.g., generating a voxel feature map based on multiple ultrasonic signals detected over time) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., generating a voxel feature map based on multiple ultrasonic signals detected over time) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., generating a voxel feature map based on multiple ultrasonic signals detected over time) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as 5 seconds, 30 seconds, 1 minute, etc.). By changing the required user attentiveness, the driver may be required to look ahead more often (e.g., at least once in a threshold time period, such as 5 seconds, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., generating a voxel feature map based on multiple ultrasonic signals detected over time) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.). One or more auxiliary devices (e.g., engine brake, exhaust brake, hydraulic retarder, electric retarder, regenerative brake, etc.) may also be controlled, for example, based on one or more features (e.g., generating a voxel feature map based on multiple ultrasonic signals detected over time) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., evaluating the engagement state of the driver) described herein.

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. Alternatively, the autonomous driving system may control the ego vehicle, for example, from an external and/or remote device, such as a server. The ego vehicle can be partially or wholly controlled (e.g., piloted, driven, etc.) remotely by a remote human driver. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, one or more example embodiments of the present disclosure will be described in detail with reference to the accompanying drawings so that those of ordinary skill in the art may easily implement the present disclosure. In the drawings, portions not related to the description are omitted in order to clearly describe the present disclosure.

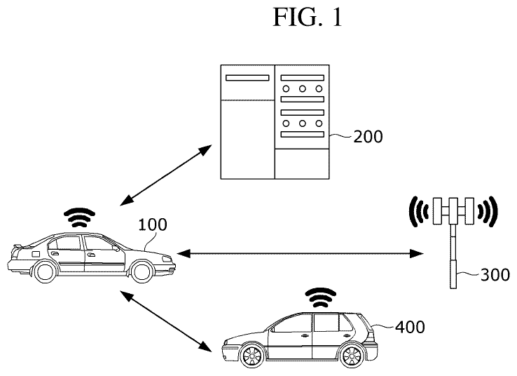

FIG. 1 is a view illustrating an example vehicle transmitting and receiving data by communicating with one or more other devices.

Referring to FIG. 1, the vehicle 100 may be driven based on electric energy or fossil energy. In the case of electric energy, the vehicle 100 may adopt a pure battery-based vehicle driven solely by a high-voltage battery or a gas-based fuel cell as an energy source. The fuel cell may utilize various types of gases capable of generating electric energy, and the gas may be filled in the vehicle 100 in a liquefied state. For instance, the gas may be hydrogen, but various other gases may also be applicable. In the case of fossil energy, the vehicle 100 may be driven based on fuels such as gasoline, diesel, or liquefied gas, and it may be equipped with an internal combustion engine that drives an actuator 116 by burning the fuel. The engine may be included in an energy generator 110 in terms of providing rotational driving force to the wheel driver 118. As another example, the vehicle 100 may be a hybrid type vehicle selectively utilizing the energy of a fossil fuel-based internal combustion engine and an electric battery to drive the actuating unit 116.

The vehicle 100 may refer to a movable device. The vehicle 100 may be a ground vehicle, such as a typical passenger or commercial vehicle, or a purpose-built vehicle (PBV) for specific purposes. The vehicle 100 may be a four-wheeled vehicle, such as a passenger car, SUV, or small truck, or a vehicle with more than four wheels, such as a bus, large truck, container carrier, or heavy equipment. The vehicle 100 may also be a robot in the broad sense of a movable means, and the robot may move using wheels, tracks, or other mobility modules.

The vehicle 100 may be controlled and driven autonomously, and autonomous driving may be implemented as semi-autonomous driving or fully autonomous driving. Fully autonomous driving may be provided as autonomous movement in which the processor 122 of the vehicle 100 fully controls the driving without user intervention, even in uncertain driving conditions. Semi-autonomous driving may be provided as autonomous movement that requires driver intervention in specific driving situations. Semi-autonomous driving may be implemented to enable manual driving by transferring control to the user when the processor 122 deactivates autonomous driving upon occurrence of such situations. According to the autonomous driving levels defined by the Society of Automotive Engineers (SAE), semi-autonomous driving may correspond to levels 1 to 4, and fully autonomous driving may correspond to level 5. Meanwhile, the vehicle 100 may perform communication with other devices 200, 300, or other vehicles 400. The other devices may include, for example, a server 200 supporting various control state management and driving of the vehicle 100, an Intelligent Transportation System (ITS) device 300 for receiving information from ITS, and various types of user devices. The server 200 may be an external device operated by a vehicle manufacturer or prepared to provide autonomous driving services and may transmit or receive connected data necessary for autonomous driving to or from the vehicle 100. The server 200 may transmit various information and software modules used for the control of the vehicle 100 in response to requests and data transmitted from the vehicle 100 and user devices to support autonomous driving and various services of the vehicle 100.

The ITS device 300, for instance, may be a Roadside Unit (RSU). The ITS device 300 may exchange vehicle perception data, driving control and state data, environmental data around the vehicle, and map data with the vehicle 100 through Vehicle-to-Infrastructure (V2I) communication to assist the user's driving or support autonomous driving of the vehicle 100. The vehicle 100 may support manual or autonomous driving by exchanging the aforementioned data with other vehicles 400 through Vehicle-to-Vehicle (V2V) communication.

The vehicle 100 may perform communication with other vehicles or devices based on cellular communication, Wireless Access in Vehicular Environment (WAVE) communication, Dedicated Short Range Communication (DSRC), or other communication methods. For instance, the vehicle 100 may use communication networks such as LTE or 5G, Wi-Fi networks, or WAVE networks for communication with the server 200, ITS device 300, and other vehicles 400. In another example, DSRC used in the vehicle 100 may be utilized for inter-vehicle communication. The communication methods among the vehicle 100, the server 200, the ITS device 300, other vehicles 400, and user devices are not limited to the example embodiment(s) described herein.

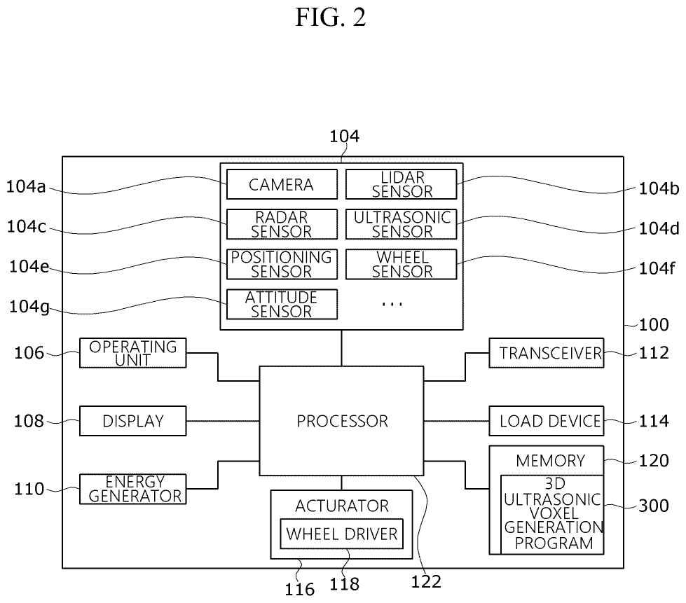

FIG. 2 is a diagram showing example modules constituting a vehicle.

The vehicle 100 may include a sensor unit (also referred to as a sensor array) 104, an operating unit 106, a display 108, a load device 114, and a transceiver 112.

The sensor unit 104 may be equipped with various types of detectors to sense various states and situations occurring in the external environment, internal system, user operations, and passenger space of the vehicle 100. Specifically, the sensor unit (also referred to as a sensor array) 104 may include one or more external-facing cameras 104a, one or more LIDAR sensors 104b, one or more radar sensors 104c, and the like to recognize dynamic and static objects existing outside the vehicle 100. The camera 104a may recognize external objects as images during the use of the vehicle 100, generate image data, and transmit the image data to the processor 122. The LIDAR sensor 104b may generate point cloud data as recognized data of external objects to generate three-dimensional spatial information identifying the shape of at least the external objects and transmit the point cloud data to the processor 122. The radar sensor 104c may generate radar data by emitting radio waves of a specific frequency around the vehicle 100 and recognizing the external objects through the reflected radio waves to identify the presence, relative distance, speed, and direction of external objects. Although the present disclosure illustrates the sensor unit 104 as including the LIDAR sensor 104b, it may not be included in other examples.

The sensor unit 104 may further include one or more ultrasonic sensors 104d, one or more positioning sensors 104e, one or more wheel sensors 104f, and one or more attitude sensors 104g to confirm its position, speed, and driving posture. The attitude sensor 104g may include a gyro sensor, angular velocity sensor, accelerometer, and the like.

The sensor unit 104 may further include other sensors not listed herein for detecting various situations.

The operating unit 106 may be configured as a module for user control for driving. For instance, the operating unit 106 may include a steering wheel for manual driving, an automatic or manual transmission actuator, an accelerator pedal, a brake pedal, a gearbox, etc. The operating unit 106 may further include an interface for the use/deactivation of the autonomous driving mode requested by the user and the selection of detailed function to utilize the autonomous driving function. The operating unit 106 may be configured as a hard-type interface provided at a predetermined position inside the vehicle 100 or a soft-type interface touchable on the display 108 to receive various requests related to autonomous driving.

The display 108 may function as a user interface. The display 108 may display the operation state, control state, route/traffic information, remaining energy information, and contents requested by the driver of the vehicle 100 as controlled by the processor 122. The display 108 may also receive driver's requests instructing the processor 122 by being configured as a touch screen detecting driver input.

The load device 114 may be mounted on the vehicle 100 and be a kind of electric device for non-driving use, excluding the driving power system such as the wheel driver 118. The load device 114 may be an auxiliary device supplied with power from the energy generator 110, such as an air conditioning system, lighting system, seat system, and various devices installed in the vehicle 100.

The transceiver 112 may support mutual communication with the server 200, ITS device 300, and surrounding vehicles 300. The transceiver 112 may include modules handling cellular communication, WAVE, DSRC communication, etc. For instance, the transceiver 116 may transmit data generated or stored during driving to the server 200 and receive data and software modules transmitted from the server 200. The transceiver 116 may also support communication with electronic devices carried by passengers inside the vehicle 100. In the present disclosure, the vehicle 100 may transmit and receive data utilized in the methods according to the present disclosure through the transceiver 116.

The vehicle 100 may also include an energy generator 114 and an actuating unit 116. The energy generator 110 may generate and supply power and electricity used in the driving power system, such as the actuating unit 118, and the non-driving power system. The non-driving power system may include, for example, the sensor unit 104, operating unit 106, display 108, load device 114, transceiver 112, and the like, and may include various components implementing sensing, interface, communication, and convenience functions, excluding components directly involved in driving operations. When the vehicle 100 is driven based on electric energy, the energy generator 110 may be configured as an electric battery charged from an external source or a combination of an electric battery and a fuel cell charging the battery. In the case of a combination of an electric battery and a fuel cell, the energy generator 110 may include a tank storing a material, such as liquefied hydrogen, used to generate power in the fuel cell. When the vehicle 100 is driven based on fossil energy, the energy generator 110 may be configured as an internal combustion engine. Additionally, when the vehicle 100 is of a hybrid type, the energy generator 110 may be provided as a combination of an internal combustion engine and an electric battery.

The actuator 116 may include at least one module implementing driving operations and may perform at least one of longitudinal control, such as acceleration and deceleration, and lateral control, such as steering, based on user requests from the operating unit 106. The actuator 116 may include mechanical components and electronic modules implementing driving operations in the wheel driver 118 to perform driving operations according to commands of the processor 122 for manual control or autonomous driving. When the vehicle 100 is operated based on electric energy, it may include an assembly for delivering the requested driving operations to the wheel driver 118. If the vehicle 100 is operated based on fossil energy, the actuator 116 may include a transmission gear module delivering the power of the internal combustion engine.

The wheel driver 118 may include a driving force generating module generating driving force for multiple wheels or transferring driving force to the wheels, a braking module decelerating the driving of the wheels, and a steering module realizing lateral control of the wheels. When the vehicle 100 is driven based on electric energy, the driving force generating module may be configured as a motor assembly generating driving force based on the power output from the electric battery. The braking module of the electric-based vehicle 100 may further have a regenerative braking function.

In addition, the vehicle 100 may include a memory 120 and a processor 122.

The memory 120 may store applications and various data for controlling the vehicle 100, and load applications or read and record data by a request of the processor 122. In the present disclosure, the memory 120 may store an application and at least one instruction for determining a traffic congestion situation for a driving area of the autonomous vehicle 100 and generating congestion control information based on the traffic congestion situation. In addition, the memory 120 may generate final longitudinal control information based on various data including congestion control information and hold applications and instructions for controlling the vehicle 100 in the traffic congestion situation according to the information.

The longitudinal control may be control related to a speed, an acceleration, and a relative distance to a surrounding vehicle of the vehicle 100. As one example, the longitudinal control may be motion control in autonomous driving. As another example, the longitudinal control may be used in manual driving as well as autonomous driving. When there is a manual operation that is different from an operation appropriate for the surrounding situation, the processor 122 may intervene in manual driving with the longitudinal control that matches the surrounding situation, or may provide longitudinal control-related data to a manual driver.

Accordingly, as one example, the longitudinal control information may include a speed and an acceleration applied to the vehicle 100. The speed and the acceleration may be generated as longitudinal data that applies to any one of a time range, a distance range, or a specific section along a route. The longitudinal control information may be described as profiles of continuous velocity and acceleration over the range or section. As another example, in addition to the speed and the acceleration, the longitudinal control information may further include control factors applied to the vehicle 100, for example, control according to a relative required distance to surrounding vehicles.

The memory 120 may manage road information, surrounding object information, and vehicle information to generate final longitudinal control information depending on the presence or absence of the traffic congestion situation.

The road information may include lane level route information, road restriction information, a road structure, a traffic sign information, and road event information related to the driving lane in which the vehicle 100 moves and surrounding lanes. In the present disclosure, the road on which the vehicle 100 moves may have a plurality of lanes, and may specifically include a driving lane on which the vehicle 100 travels and surrounding lanes near the driving lane. The lane level route information may be obtained from lane images or map information acquired from, for example, the camera 104a. The map information is, for example, a lane-level precision map, and may be obtained from an external device such as the server 200 and managed in the memory 120. The lane level route information may include a trajectory (or route) of each lane, its width, parameters applied to functions related to each lane, and the like. The road restriction information may be a speed limit required on the road on which the vehicle 100 is traveling and a vehicle behavior required to comply with regulations related to the corresponding road. The traffic sign information may be information related to traffic control and guidance displayed on a road surface and signs installed on the road. The traffic sign information may include, for example, crosswalks, stop lines, U-turns, left turns, speed limits, milestones, and the like.

The road structure may be related to a road shape. The road structure may include information representing, for example, the number of lanes, a road geometry such as a straight or curved line, a road merging section, a road branch section, a road gradient, a tunnel section, road three-dimensionality (e.g., a ground road and an elevated road), and the like. The road event information may be information related to an event on the road. The road event information may include, for example, a construction zone, road event information, and a slow-speed section due to bad weather.

The surrounding object information may include data related to the behavior of dynamic objects around the vehicle 100. The surrounding object information is behavior data derived by analyzing dynamic objects obtained from at least one of the sensor unit 104, the intelligence transportation system (ITS) device 300, and other vehicles 100 by the processor 122, and the behavior data may be managed in the memory 120. Dynamic objects may be, for example, surrounding vehicles, pedestrians, or other types of mobility, and other types of mobility may be personal mobility such as bicycles or electric scooters. The behavior of the dynamic object may include information related to the position, speed, motion, or the like, of the dynamic object. The speed may include, for example, the speed of each surrounding vehicle and the average speed of surrounding vehicles in a predetermined area. The motion may be defined based on a movement pattern of the dynamic object. Taking a vehicle as an example, the motion may be referred to as a driving motion of the vehicle, and the driving motion may be divided into lane keeping driving and biased driving. The lane keeping driving may be a motion in which surrounding vehicles substantially travel along center areas of their own lanes without deviating from the lanes, thereby causing no interference with the driving of the vehicle traveling in the adjacent lane. The bias driving may be a motion in which a surrounding vehicle does not deviate from its own lane, but travels eccentrically from the center area and approaches the driving lane used by the vehicle or some of surrounding vehicles deviate from their own lanes and enter the lane of the vehicle, thereby causing interference with the driving of the vehicle.

The vehicle information may refer to information related to the vehicle. The vehicle information may include data related to a longitudinal state of the vehicle 100, a sensing detection range of the surrounding environment of the sensor unit 104 mounted on the vehicle 100, and autonomous driving control. The longitudinal state may include a driving lane, a position, a speed, an acceleration, and a distance to a surrounding vehicle of the vehicle 100, and may be acquired by the camera 104a, the positioning sensor 104e, the wheel sensor 104f, the attitude sensor 104g, the radar sensor 104c, and the like, and managed in the memory 120. The sensing detection range may be a distance and an area detected by the detection performance of the sensor unit 104 that varies depending on the road shape, weather, or the like. The road shape and weather may be confirmed by road information, surrounding situations detected by the sensor unit 104, and external information provided by the server 200 or the like. Specifically, the detection range of the camera 104a, the LIDAR sensor 104b, and the radar sensor 104c varies depending on a gradient of a front road and the weather, and the variable detection range may be managed in the memory 120 as the sensing detection range. As another example, the detection range according to the gradient and weather may be stored in the memory 120 in a pre-tabulated form.

The data related to autonomous driving control may include a control plan according to various driving situations of the vehicle 100. Here, the driving situation may be, for example, evasive driving, following a preceding vehicle, changing lanes, driving at an intersection, or the like. In the present disclosure, the data may be described mainly in terms of a control plan (or an action plan) related to control transfer from autonomous driving to manual driving among various driving situations, but is not limited thereto. The action plan may be a plan to reduce instability due to the control transfer, that is, the risk of autonomous driving. When a driving situation that the processor 122 cannot handle occurs, the action plan related to the control transfer may include, for example, a control to notify a user of the transfer in advance and move the vehicle 100 to a safe area on the road at a specific speed and stop the vehicle 100 when the user does not operate the vehicle 100 for a specified period of time after the notification. The transfer-related action plan is not limited to the above-described examples and may be established using various methods and speeds.

The map information stored in the memory 120 may be used to generate a driving route set in the vehicle 100 by the request of the user or the processor 122. In addition, the map information is utilized for autonomous driving, and may include a low-precision map or include a high-precision map together with the map. The map information may be provided to have various information and data included in driving environment information.

The processor 122 may perform overall control of the vehicle 100. The processor 122 may be configured to execute applications and instructions stored in the memory 120.

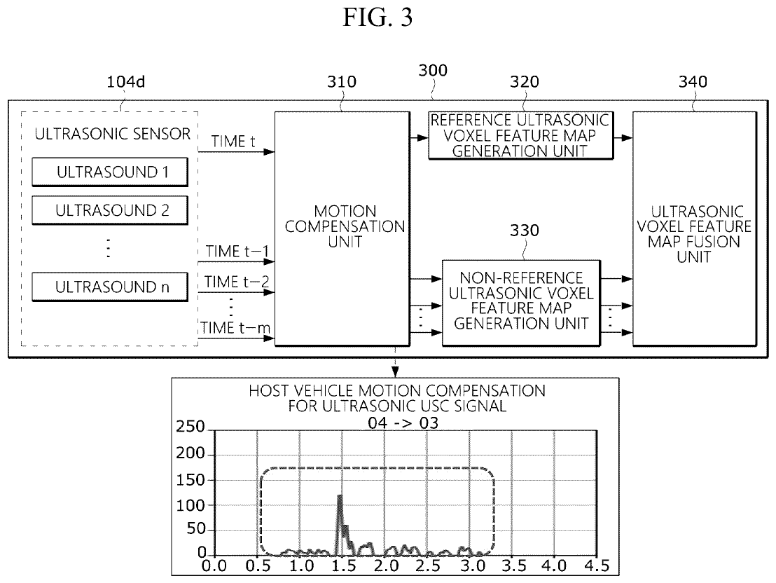

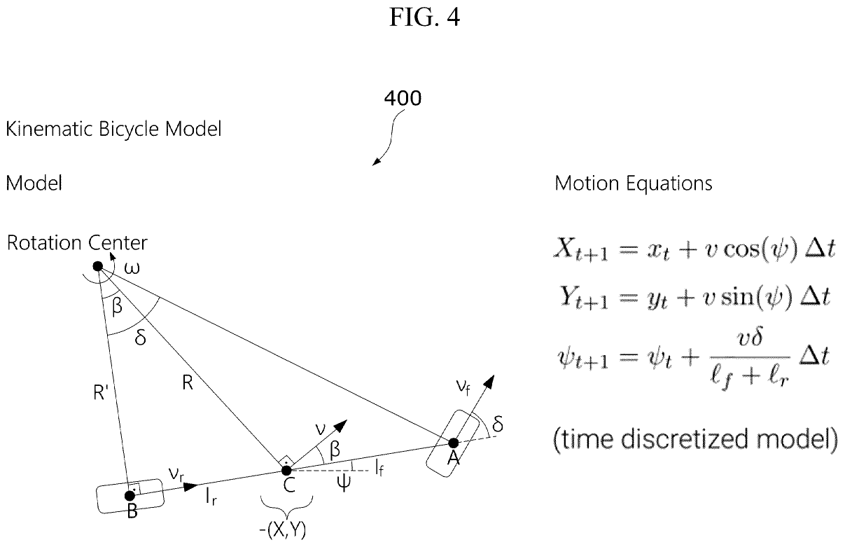

FIG. 3 is a diagram conceptually showing a function of an example 3D ultrasonic voxel program of FIG. 2. FIG. 4 is a diagram illustrating a kinematic bicycle model used in an example D ultrasonic voxel generation program.

Referring to FIG. 3, the 3D ultrasonic voxel generation program may include a motion compensation unit 310, a reference ultrasonic voxel feature map generation unit 320, a non-reference ultrasonic voxel feature map generation unit 330, and an ultrasonic voxel feature map fusion unit 340.

If only ultrasonic sensor signals detected at the same time are used, it may be difficult to know whether an object exists at the same distance, and therefore it is necessary to generate an ultrasonic voxel using ultrasonic sensor signals at various times. Accordingly, it may be necessary to generate a non-reference ultrasonic voxel feature map by using not only ultrasonic signals at time (e.g., reference time) t (hereinafter referred to as “reference ultrasonic signals”), but also ultrasonic signals at times other than time (e.g., non-reference times) t (hereinafter referred to as “non-reference ultrasonic signals”). For example, the non-reference ultrasonic signals may be ultrasonic signals detected by an ultrasonic sensor 104d at times t−1, t−2, . . . , and t−m (m is a natural number). The ultrasonic signals (e.g., obtained from one or more ultrasonic sensors mounted on a vehicle) may represent (e.g., indicate) one or more objects located in a surrounding environment of the vehicle.

Considering the above, the reference ultrasonic voxel feature map generation unit 320 and the non-reference ultrasonic voxel feature map generation unit 330 need to match spatiotemporal information in order to fuse (e.g., combine, merge, etc.) the reference ultrasonic signals with the non-reference ultrasonic signals, and the motion compensation unit 310 may compensate for a motion of a vehicle 100 in order to match the spatial information. In this case, the motion compensation may be performed based on the reference ultrasonic signals.

Specifically, the motion compensation unit 310 may check initial position information (xinit, yinit) of a host-vehicle and compensate for position information of the vehicle by utilizing a kinematic bicycle model 400 (see FIG. 4). That is, the motion compensation unit 310 may reflect a speed v and heading angle ψ of the vehicle in the kinematic bicycle model to compensate for the position information of the vehicle. Here, the speed v of the vehicle may be calculated using wheel speeds (e.g., rotational speeds) [vwfl, vwfr, vwrl, vwrr] of the vehicle (where vwfl represents a speed of a front left wheel, Vwfr represents a speed of a front right wheel, Vwrl represents a speed of a rear left wheel, and Vwrr represents a speed of a rear left wheel), and a heading angle σ may be calculated by using a steering angle of the vehicle 100.

Further, the motion compensation unit 310 may calculate an ultrasonic mounting position (xuss, yuss) and a mounting angle Δuss through the vehicle speed v and the heading angle σ. For example, the motion compensation unit 310 may calculate an ultrasonic mounting position for motion compensation of the vehicle using the following Equation 1, and may calculate the mounting angle Δuss using the following Equation 2.

$$[ \begin{matrix}x \\ y\end{matrix} ] = [ \begin{matrix}cos ψ & - sin ψ \\ sin ψ & cos ψ\end{matrix} ] [ \begin{matrix}{x}_{uss} \\ {y}_{uss}\end{matrix} ] + [ \begin{matrix}{x}_{ego} \\ {y}_{ego}\end{matrix} ] \qquad [ Equation 1 ]$$

$$Δ = {Δ}_{uss} - ψ \qquad [ Equation 2 ]$$

Ultimately, the motion compensation unit 310 may perform motion compensation on non-reference ultrasonic signals through the above-described operation, and provide the motion-compensated signals to the reference ultrasonic voxel feature map generation unit 320 and the non-reference ultrasonic voxel feature map generation unit 330. Accordingly, the reference ultrasonic voxel feature map generation unit 320 and the non-reference ultrasonic voxel feature map generation unit 330 may generate the ultrasonic voxel feature map using the motion-compensated signals.

The reference ultrasonic voxel feature map generation unit 320 may generate the reference ultrasonic voxel feature map using ultrasonic signals at time t (e.g., reference time), that is, the reference ultrasonic signals (e.g., one or more first ultrasonic signals detected at a reference time). The reference ultrasonic voxel feature map generation unit 320 may perform filtering on the reference ultrasonic signals, generate ultrasonic voxel heat maps, and concatenate the ultrasonic voxel heat maps.

Specifically, the reference ultrasonic voxel feature map generation unit 320 may perform filtering on a signal intensity value (RAW data) for each SGW of the reference ultrasonic signals. For example, the reference ultrasonic voxel feature map generation unit 320 may perform signal filtering on a signal that exceeds a maximum detection distance (e.g., the maximum distance at which the ultrasonic sensor 104d is capable of detecting the object) among the reference ultrasonic signals. To this end, the reference ultrasonic voxel feature map generation unit 320 may include a filter of which a maximum detection distance is set. Further, the reference ultrasonic voxel feature map generation unit 320 may perform correction on the reference ultrasonic signals by using a signal generation position and center angle for each SGW obtained from a vehicle compensation model.

The reference ultrasonic voxel feature map generation unit 320 may receive the signal intensity value for each SGW from the ultrasonic sensor 104d, and may generate the ultrasonic voxel heat map by applying the signal intensity value for each SGW to the voxel grid. For example, the reference ultrasonic voxel feature map generation unit 320 may sample m signals as much as a horizontal FOV and m signals as much as a vertical FOV with reference to the center angle. The sampling of the horizontal FOV and the sampling of the vertical FOV may be performed through the following Equations 3 and 4, respectively.

$$Sampling of horizontal FOV \text{:} θ = {[ {θ}_{m} ]}_{m = 1}^{M} \qquad [ Equation 3 ]$$

$$Sampling of vertical FOV \text{:} ϕ = {[ {ϕ}_{n} ]}_{n = 1}^{N} \qquad [ Equation 4 ]$$

The reference ultrasonic voxel feature map generation unit 320 may calculate coordinates of each ultrasonic distance and assign the signal intensity value to the voxel included in the coordinates to construct the ultrasonic voxel heat map. In this case, the coordinates of each ultrasonic distance may be calculated by using Equation 5 below.

$$[ Equation 5 ]$$

$$( {x}_{mn} , {y}_{mn} , {z}_{mn} ) = ( d \cdot cos {θ}_{m} \cdot sin {ϕ}_{n} , d \cdot sin {θ}_{m} \cdot sin {ϕ}_{n} , d \cdot cos {ϕ}_{n} ) )$$

Thereafter, the reference ultrasonic voxel feature map generation unit 320 may concatenate the ultrasonic signals to collect all voxel feature maps for each SGW.

The non-reference ultrasonic voxel feature map generation unit 330 may generate the non-reference ultrasonic voxel feature map by using the non-reference ultrasonic signals. The generation of the non-reference ultrasonic voxel feature map may be performed in the same manner as the generation of the reference ultrasonic voxel feature map described above.

The ultrasonic voxel feature map fusion unit 340 may fuse (e.g., combine, merge, etc.) the reference ultrasonic voxel feature map with the non-reference ultrasonic voxel feature map to generate a final ultrasonic voxel feature map. Specifically, the ultrasonic voxel feature map fusion unit 340 may concatenate the reference ultrasonic voxel feature map and the reference ultrasonic voxel feature map for all times to generate a fused (e.g., combined, merged, etc.) ultrasonic voxel feature map Fϵ(X, Y, Z, (T×N_{sgw})). The ultrasonic voxel feature map fusion unit 340 may input the voxel feature map summed in respective channel axes to an ultrasonic feature map generation model. In response thereto, the ultrasonic feature map generation model may output a result of calculating an occupancy probability of each voxel by utilizing a sigmoid function. The ultrasonic voxel feature map fusion unit 340 may apply a result value of the ultrasonic feature map generation model to the fused ultrasonic voxel feature map to generate a final voxel feature map fused on a time axis. The vehicle (e.g., an autonomous driving function or operation of the vehicle) may be controlled based on an ultrasonic voxel feature map (e.g., the final ultrasonic voxel feature map). For example, the vehicle may be controlled based on the ultrasonic voxel feature map (e.g., the final ultrasonic voxel feature map) to avoid one or more objects in the surrounding environment of the vehicle.

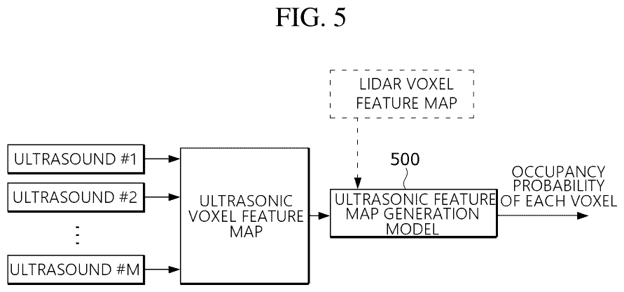

FIG. 5 is a diagram illustrating an ultrasonic feature map generation model used in an example 3D ultrasonic voxel program.

Referring to FIG. 5, an ultrasonic feature map generation model 500 may be a model trained to input an ultrasonic voxel feature map and output the result of calculating the occupancy probability of each voxel. The ultrasonic feature map generation model 500 may be trained using a LIDAR voxel feature map and a value of occupancy probability of each voxel as GT of the occupancy probability of each voxel grid.

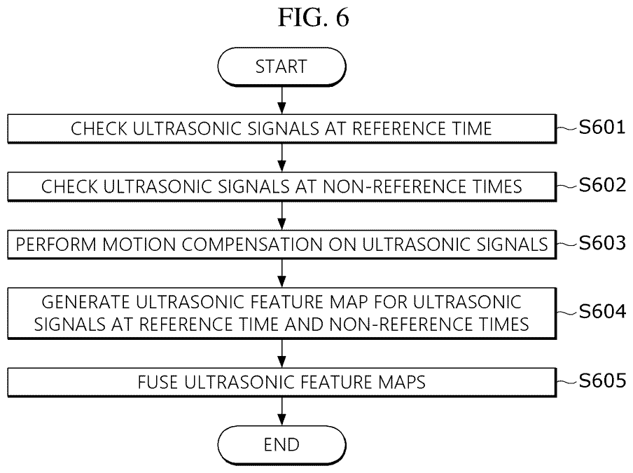

FIG. 6 is a flowchart illustrating an operation of an example ultrasonic feature map generation method.

The ultrasonic feature map generation method may be performed by the processor of the vehicle described herein.

First, the processor 122 may check ultrasonic signals (S601 and S602). When only ultrasonic sensor signals detected at the same time are used, it is difficult to know whether an object exists at the same distance, and therefore it is necessary to generate an ultrasonic voxel using ultrasonic sensor signals at various times. Accordingly, it is necessary to generate the non-reference ultrasonic voxel feature map by using not only ultrasonic signals at time t (hereinafter referred to as “reference ultrasonic signals”), but also ultrasonic signals at times other than time t (hereinafter referred to as “non-reference ultrasonic signals”). For example, the non-reference ultrasonic signals may be ultrasonic signals detected by the ultrasonic sensor 104d at times t−1, t−2, . . . , and t−m (m is a natural number).

In order to fuse (e.g., combine, merge, etc.) the reference ultrasonic signals with the non-reference ultrasonic signals, it is necessary to match spatiotemporal information, and in order to match spatial information, the processor 122 may check initial position information (xinit, yinit) of the vehicle and compensate (e.g., adjust) the position information of the vehicle by utilizing the kinematic bicycle model 400 (see FIG. 4). That is, the processor 122 may reflect the speed v and heading angle ψ of the vehicle in the kinematic bicycle model to compensate for the position information of the vehicle. Here, the speed v of the vehicle may be calculated using wheel speeds [vwfl, vwfr, vwrl, vwrr] of the vehicle (where vwfl represents the speed of the front left wheel, Vwfr represents the speed of the front right wheel, Vwrl represents the speed of the rear left wheel, and Vwrr represents the speed of the rear left wheel), and the heading angle σ may be calculated by using the steering angle of the vehicle 100.

Further, the processor 122 may calculate the ultrasonic mounting position (xuss, yuss) and the mounting angle Δuss through the vehicle speed v and the heading angle σ. For example, the ultrasonic mounting position (xuss, yuss) and the mounting angle Δuss may be calculated by using Equations 1 and 2 described above.

Thus, the processor 122 may perform motion compensation on the ultrasonic signals through the above-described operation and provide the motion-compensated signals S603.

The processor 122 may generate a reference ultrasonic voxel feature map using the ultrasonic signals at time t, that is, the reference ultrasonic signals (S604). The processor 122 may perform filtering on the reference ultrasonic signals, generate ultrasonic voxel heatmaps, and concatenate the ultrasonic voxel heatmaps.

Specifically, the processor 122 may perform filtering on a signal intensity value (RAW data) for each SGW of the reference ultrasonic signals. For example, the processor 122 may perform signal filtering on a signal that exceeds the maximum detection distance (e.g., the maximum distance at which the ultrasonic sensor 104d is capable of detecting the object) among the reference ultrasonic signals. To this end, the processor 122 may include a filter of which a maximum detection distance is set.

Further, the processor 122 may perform correction on the reference ultrasonic signals by using a signal generation position and center angle for each SGW obtained from the vehicle compensation model.

The processor 122 may receive the signal intensity value for each SGW from the ultrasonic sensor 104d whose ultrasonic generation position and center angle are compensated through the motion compensation unit 310, and may generate the ultrasonic voxel heat map by applying the signal intensity value for each SGW to the voxel grid. For example, the processor 122 may sample m signals as much as a horizontal FOV and m signals as much as a vertical FOV with reference to the center angle. The sampling of the horizontal FOV and the sampling of the vertical FOV may be performed through Equations 3 and 4 described above, respectively.

The processor 122 may calculate coordinates of each ultrasonic distance and assign the signal intensity value to the voxel included in the coordinates to construct the ultrasonic voxel heat map. In this case, the coordinates of each ultrasonic distance may be calculated by using Equation 5 described above.

The processor 122 may concatenate the ultrasonic signals to collect all voxel feature maps for each SGW.

Further, the processor 122 may generate the non-reference ultrasonic voxel feature map by using the non-reference ultrasonic signals. The generation of the non-reference ultrasonic voxel feature map may be performed in the same manner as the generation of the reference ultrasonic voxel feature map described above.

In operation S605, the processor 122 may fuse (e.g., combine, merge, etc.) the reference ultrasonic voxel feature map with the non-reference ultrasonic voxel feature map to generate a final ultrasonic voxel feature map. Specifically, the ultrasonic voxel feature map fusion unit 340 may concatenate the reference ultrasonic voxel feature map and the reference ultrasonic voxel feature map for all times to generate a fused ultrasonic voxel feature map Fϵ(X, Y, Z, (T×N_{sgw})). The processor 122 may input the voxel feature map summed in respective channel axes to the ultrasonic feature map generation model. In response thereto, the ultrasonic feature map generation model may output a result of calculating the occupancy probability of each voxel by utilizing a sigmoid function. The processor 122 may apply a result value of the ultrasonic feature map generation model to the fused ultrasonic voxel feature map to generate a final voxel feature map fused in a time axis.

According to the present disclosure, it is possible to construct an ultrasonic voxel feature map having a sophisticated 3D voxel expression by combining ultrasonic signals detected at different times.

Further, according to the present disclosure, it is possible to resolve spatial ambiguity and reliably detect an object in various situations generated based on ultrasonic signals by combining ultrasonic signals to construct an ultrasonic voxel feature map.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments of the present disclosure, the functions mentioned in the steps may occur out of order. For example, two steps illustrated in succession may in fact be performed substantially simultaneously, or the steps may sometimes be performed in a reverse order depending on the corresponding function.

In accordance with an aspect of the present disclosure, there is provided a method for generating a 3D ultrasonic voxel, the method comprises: determining ultrasonic signals detected from ultrasonic sensors mounted on a vehicle included in at a plurality of times; determining ultrasonic signals detected at a reference time among the plurality of times and ultrasonic signals detected at non-reference times other than the reference time; processing motion compensation on the ultrasonic signals detected at the reference time and the ultrasonic signals detected at the non-reference times; generating a reference ultrasonic voxel feature map by using the motion-compensated ultrasonic signals detected at the reference time; generating a non-reference ultrasonic voxel feature map by using the motion-compensated ultrasonic signals detected at the non-reference times; and generating a final ultrasonic voxel feature map by fusing the reference ultrasonic voxel feature map with the non-reference ultrasonic voxel feature map for each time.

The processing of the motion compensation may include determining a speed information of the vehicle and a heading angle information of the vehicle; determining the position information of the vehicle by applying the determined speed information of the vehicle and the heading angle information of the vehicle to initial the position information of the vehicle; and processing the motion compensation by reflecting the determined position information of the vehicle.

The determining of the speed information of the vehicle and the heading angle information of the vehicle may include determining a wheel speed information of a plurality of wheels included in the vehicle, and determining the speed information of the vehicle using the wheel speed information of the vehicle.

The determining of the speed information of the vehicle and the heading angle information of the vehicle may include determining a steering angle information of the vehicle and determining the speed information of the vehicle using the steering angle information of the vehicle.

The determining of the speed information of the vehicle and the heading angle information of the vehicle may include determining a mounting angle and mounting position of the ultrasonic sensors using the speed information of the vehicle and the heading angle information of the vehicle.

The determining generating of the reference ultrasonic voxel feature map may include processing filtering of signals exceeding a maximum detection distance among the ultrasonic signals detected at the reference time; and projecting signal intensities of the ultrasonic signals detected at the reference time onto voxels to generate an ultrasonic voxel heat map at the reference time.

The generating of the non-reference ultrasonic voxel feature map may include processing filtering of signals exceeding the maximum detection distance among the ultrasonic signals detected at the non-reference times; and projecting signal intensities of the ultrasonic signals detected at the non-reference times onto voxels to generate an ultrasonic voxel heat map at the non-reference times.

The generating of the final ultrasonic voxel feature map may include concatenating the reference ultrasonic voxel feature map and the non-reference ultrasonic voxel feature maps for each time point to generate a voxel feature map; and summing the voxel feature maps for each channel, inputting the voxel feature map to an ultrasonic feature map generation model, and reflecting a value output through the ultrasonic feature map generation model to check a final ultrasonic voxel feature map.

In accordance with another aspect of the present disclosure, there is provided a vehicle, the vehicle comprises: a plurality of ultrasonic sensors mounted on a predetermined position of the vehicle; a memory configured to store an ultrasonic voxel generation program; a processor configured to load the ultrasonic voxel generation program from the memory, wherein the processor is configured to execute the ultrasonic voxel generation program to: determine ultrasonic signals detected from the plurality of ultrasonic sensors at a plurality of times; process motion compensation on the ultrasonic signals detected at the reference time among the plurality of times and the ultrasonic signals detected at the non-reference times among the plurality of times; generate a reference ultrasonic voxel feature map by using the motion-compensated ultrasonic signals detected at the reference time; generate a non-reference ultrasonic voxel feature map by using the motion-compensated ultrasonic signals detected at the non-reference times; and generate a final ultrasonic voxel feature map by fusing the reference ultrasonic voxel feature map with the non-reference ultrasonic voxel feature map for each time.

The processor may be configured to determine a speed information of the vehicle and a heading angle information of the vehicle; determine the position information of the vehicle by applying the determined speed information of the vehicle and the determined heading angle information of the vehicle to initial position information of the vehicle; and process the motion compensation by reflecting the determined position information of the vehicle.

The processor may be configured to determine a wheel speed information of a plurality of wheels included in the vehicle, and determine the speed information of the vehicle using the wheel speed information of the vehicle

The processor may be configured to determine a steering angle information of the vehicle and determine the speed information of the vehicle using the steering angle information of the vehicle.

The processor may be configured to determine a mounting angle and a mounting position each of the ultrasonic sensors using the speed information of the vehicle and the heading angle information of the vehicle.

The processor may be configured to process filtering of signals exceeding a maximum detection distance among the ultrasonic signals detected at the reference time and the ultrasonic signals detected at the non-reference time; and project signal intensities of the ultrasonic signals at the reference time and the ultrasonic signals at the non-reference time onto voxels to generate an ultrasonic voxel heat map.

The processor may be configured to concatenate the reference ultrasonic voxel feature map and the non-reference ultrasonic voxel feature maps for each time point to generate a voxel feature map; and sum the voxel feature maps for each channel, input the voxel feature map to an ultrasonic feature map generation model, and determine a final ultrasonic voxel feature map by using a value output through the ultrasonic feature map generation model.

In accordance with another aspect of the present disclosure, there is provided a non-transitory computer-readable storage medium including computer executable instructions, wherein the instructions, when executed by a processor, cause the processor to perform a method for generating a 3D ultrasonic voxel, the method comprise: determining ultrasonic signals detected from ultrasonic sensors mounted on a vehicle included in at a plurality of times; determining ultrasonic signals detected at a reference time among the plurality of times and ultrasonic signals detected at non-reference times other than the reference time; processing motion compensation on the ultrasonic signals detected at the reference time and the ultrasonic signals detected at the non-reference times; generating a reference ultrasonic voxel feature map by using the motion-compensated ultrasonic signals detected at the reference time; generating a non-reference ultrasonic voxel feature map by using the motion-compensated ultrasonic signals detected at the non-reference times; and generating a final ultrasonic voxel feature map by fusing the reference ultrasonic voxel feature map with the non-reference ultrasonic voxel feature map for each time.

The above description is merely descriptions of one or more example embodiments of the present disclosure, and it will be understood by those skilled in the art that various changes and modifications can be made without departing from original characteristics of the present disclosure. Therefore, the example embodiment(s) disclosed in the present disclosure are intended to explain, not to limit, the technical scope of the present disclosure, and the technical scope of the present disclosure is not limited by the example embodiment(s). The protection scope of the present disclosure should be interpreted based on the following claims and it should be appreciated that all technical scopes included within a range equivalent thereto are included in the protection scope of the present disclosure.

What is claimed is:

1. A method performed by an apparatus of a vehicle, comprising:
obtaining, from one or more ultrasonic sensors mounted on the vehicle, a plurality of ultrasonic signals detected at a plurality of times, wherein the plurality of ultrasonic signals represent one or more objects in a surrounding environment of the vehicle;
determining, among the plurality of ultrasonic signals:
one or more reference ultrasonic signals detected at a reference time of the plurality of times, and
one or more non-reference ultrasonic signals detected at one or more non-reference times of the plurality of times;
processing motion compensation on the one or more reference ultrasonic signals and the one or more non-reference ultrasonic signals;
generating, based on the one or more motion-compensated reference ultrasonic signals, a reference ultrasonic voxel feature map;
generating, based on the one or more motion-compensated non-reference ultrasonic signals, one or more non-reference ultrasonic voxel feature maps;
generating a final ultrasonic voxel feature map by combining the reference ultrasonic voxel feature map and the one or more non-reference ultrasonic voxel feature maps; and
controlling, based on the final ultrasonic voxel feature map, an autonomous driving operation of the vehicle.

2. The method of claim 1, wherein the processing of the motion compensation comprises:
determining a speed of the vehicle and a heading angle of the vehicle;
determining a position of the vehicle by applying the determined speed and the heading angle to an initial position of the vehicle; and
processing the motion compensation based on the determined position of the vehicle.

3. The method of claim 2, wherein the determining of the speed of the vehicle and the heading angle of the vehicle comprises:
determining a wheel speed of a plurality of wheels of the vehicle; and
determining the speed of the vehicle based on the wheel speed of the vehicle.

4. The method of claim 2, wherein the determining of the speed of the vehicle and the heading angle of the vehicle comprises:
determining a steering angle of the vehicle; and
determining the speed of the vehicle based on the steering angle of the vehicle.

5. The method of claim 2, further comprising:
determining, based on the speed of the vehicle and the heading angle of the vehicle, a mounting angle of the one or more ultrasonic sensors and a mounting position of the one or more ultrasonic sensors.

6. The method of claim 1, wherein the generating of the reference ultrasonic voxel feature map comprises:
filtering, among the one or more reference ultrasonic signals, one or more signals that exceed a maximum detection distance of the one or more ultrasonic sensors; and
generating a first ultrasonic voxel heat map at the reference time by projecting signal intensities of the one or more reference ultrasonic signals onto one or more first voxels, and
wherein the generating of the one or more non-reference ultrasonic voxel feature maps comprises:
filtering, among the one or more non-reference ultrasonic signals, one or more signals that exceed the maximum detection distance of the one or more ultrasonic sensors; and
generating second ultrasonic voxel heat maps at the non-reference times by projecting signal intensities of the one or more non-reference ultrasonic signals onto one or more second voxels.

7. The method of claim 1, wherein the generating of the final ultrasonic voxel feature map comprises:
concatenating the reference ultrasonic voxel feature map and the one or more non-reference ultrasonic voxel feature maps to generate a voxel feature map;
summing the voxel feature map by each channel of the voxel feature map; and
generating the final ultrasonic voxel feature map by inputting the summed voxel feature map to an ultrasonic feature map generation model.

8. A vehicle comprising:
one or more ultrasonic sensors configured to detect, at a plurality of times, a plurality of ultrasonic signals representing one or more objects in a surrounding environment of the vehicle;
a processor; and
a memory storing at least one instruction that is configured, when executed by the processor, to cause the vehicle to:
process motion compensation on:
one or more reference ultrasonic signals, of the plurality of ultrasonic signals, that are detected at a reference time of the plurality of times, and
one or more non-reference ultrasonic signals, of the plurality of ultrasonic signals, that are detected at one or more non-reference times of the plurality of times;
generate, based on the one or more motion-compensated reference ultrasonic signals, a reference ultrasonic voxel feature map;
generate, based on the one or more motion-compensated non-reference ultrasonic signals, one or more non-reference ultrasonic voxel feature maps;
generate a final ultrasonic voxel feature map by combining the reference ultrasonic voxel feature map and the one or more non-reference ultrasonic voxel feature maps; and
control, based on the final ultrasonic voxel feature map, an autonomous driving operation of the vehicle.

9. The vehicle of claim 8, wherein the at least one instruction is configured, when executed by the processor, to cause the vehicle to process the motion compensation by:
determining a speed of the vehicle and a heading angle of the vehicle;
determining a position of the vehicle by applying the determined speed and the determined heading angle to an initial position of the vehicle; and
processing the motion compensation based on the determined position of the vehicle.

10. The vehicle of claim 9, wherein the at least one instruction is configured, when executed by the processor, to cause the vehicle to determine the speed of the vehicle and the heading angle of the vehicle by:
determining a wheel speed of a plurality of wheels of the vehicle; and
determining the speed of the vehicle based on the wheel speed of the vehicle.

11. The vehicle of claim 9, wherein the at least one instruction is configured, when executed by the processor, to cause the vehicle to determine the speed of the vehicle and the heading angle of the vehicle by:
determining a steering angle of the vehicle; and
determining the speed of the vehicle based on the steering angle of the vehicle.

12. The vehicle of claim 9, wherein the at least one instruction is configured, when executed by the processor, to further cause the vehicle to:
determine, based on the speed of the vehicle and the heading angle of the vehicle, a mounting angle of the one or more ultrasonic sensors and a mounting position of the one or more ultrasonic sensors.

13. The vehicle of claim 8, wherein the at least one instruction is configured, when executed by the processor, to further cause the vehicle to:
filter, among the one or more reference ultrasonic signals and the one or more non-reference ultrasonic signals, one or more signals that exceed a maximum detection distance of the one or more ultrasonic sensors; and
generating an ultrasonic voxel heat map by project signal intensities of the one or more reference ultrasonic signals and the one or more non-reference ultrasonic signals onto voxels.

14. The vehicle of claim 8, wherein the at least one instruction is configured, when executed by the processor, to cause the vehicle to generate the final ultrasonic voxel feature map by:
concatenating the reference ultrasonic voxel feature map and the one or more non-reference ultrasonic voxel feature maps to generate a voxel feature map;
summing the voxel feature map by each channel of the voxel feature map; and
generating the final ultrasonic voxel feature map by inputting the summed voxel feature map to an ultrasonic feature map generation model.

15. A non-transitory computer-readable medium storing instructions that, when executed by a computing device, cause the computing device to:
obtain, from an ultrasonic sensor of a vehicle at a first time, a first non-reference signal representing one or more objects in a surrounding environment of the vehicle;
obtain, from the ultrasonic sensor at a second time after the first time, a second non-reference signal representing the one or more objects;
obtain, from the ultrasonic sensor at a third time after the second time, a reference signal representing the one or more objects;
generate, based on the first non-reference signal and the second non-reference signal, a plurality of non-reference ultrasonic voxel feature maps;
generate, based on the reference signal, a reference ultrasonic voxel feature map; and
control, based on the reference ultrasonic voxel feature map and the plurality of non-reference ultrasonic voxel feature maps, an autonomous driving operation of the vehicle.

16. The non-transitory computer-readable medium of claim 15, wherein the instructions, when executed by the computing device, further cause the computing device to:
process motion compensation on the first non-reference signal, the second non-reference signal, and the reference signal.

17. The non-transitory computer-readable medium of claim 15, wherein the instructions, when executed by the computing device, cause the computing device to control the autonomous driving operation of the vehicle by:
causing the vehicle to avoid the one or more objects.
